(19) United States
(12) Patent Application Publication
(10) Pub. No.: US 2014/0242560 A1
(43) Pub. Date: Aug. 28, 2014

(54) FACIAL EXPRESSION TRAINING USING FEEDBACK FROM AUTOMATIC FACIAL EXPRESSION RECOGNITION

(71) Applicant: Emotient, San Diego, CA (US)

(72) Inventors: Javier MOVELLAN, La Jolla, CA (US); Marian Steward BARTLETT, San Diego, CA (US); Ian FASEL, San Diego, CA (US); Gwen Ford LITTLEWORT, Solana Beach, CA (US); Joshua SUSSKIND, La Jolla, CA (US); Ken Denman, Cherry Hills Village, CO (US); Jacob WHITEHILL, Cambridge, MA (US)

(73) Assignee: Emotient, San Diego, CA (US)

(21) Appl. No.: 14/182,286

(22) Filed: Feb. 17, 2014

Related U.S. Application Data
(60) Provisional application No. 61/765,570, filed on Feb. 15, 2013.

(51) Int. Cl. G09B 19/00

(52) U.S. Cl. CPC G09B 19/00
USPC 434/236

(57) ABSTRACT

A machine learning classifier is trained to compute a quality measure of a facial expression with respect to a predetermined emotion, affective state, or situation. The expression may be of a person or an animated character. The quality measure may be provided to a person. The quality measure may also used to tune the appearance parameters of the animated character, including texture parameters. People may be trained to improve their expressiveness based on the feedback of the quality measure provided by the machine learning classifier, for example, to improve the quality of customer interactions, and to mitigate the symptoms of various affective and neurological disorders. The classifier may be built into a variety of mobile devices, including wearable devices such as Google Glass and smart watches.

### CROSS-REFERENCE TO RELATED APPLICATION

This application claims priority from U.S. provisional patent application Ser. No. 61/765,570, entitled FACIAL EXPRESSION TRAINING USING FEEDBACK FROM AUTOMATIC FACIAL EXPRESSION RECOGNITION, filed on Feb. 15, 2013, Attorney Docket Reference MPT-1017-PV, which is hereby incorporated by reference in its entirety as if fully set forth herein, including text, figures, claims, tables, and computer program listing appendices (if present), and all other matter in the United States provisional patent application.

### FIELD OF THE INVENTION

This document generally relates to utilization of feedback from automatic recognition/analysis systems for recognizing expressions conveyed by faces, head poses, and/or gestures. In particular, the document relates to the use of feedback for training individuals to improve their expressivity, training animators to improve their ability to generate expressive animation characters, and to automatic selection of animation parameters for improved expressivity.

### BACKGROUND

There is a need for helping people—whether actors, customer service representatives, people with affective or neurological/motor control disorders, or simply people who want to improve their non-verbal communication skills—to learn improved control of their facial expressions, head poses, and/or gestures. There is an additional need to improve parameter selection in computer animation, including parameter selection for texture control. There is also a need to improve the quality of expressivity of facial expression in computer animation, including expression morphology, expression dynamics, and changes in facial texture caused by the changes in morphology and dynamics of the facial expression. This document describes methods, apparatus, and articles of manufacture that may satisfy these and possibly other needs.

### SUMMARY

In an embodiment, a computer-implemented method includes receiving from a user device facial expression recording of a face of a user; analyzing the facial expression recording with a machine learning classifier to obtain a quality measure estimate of the facial expression recording with respect to a predetermined targeted facial expression; and sending to the user device the quality measure estimate for displaying the quality measure to the user.

In an embodiment, a computer-implemented method for setting animation parameters includes synthesizing an animated face of a character in accordance with current values of one or more animation parameters, the one or more animation parameters comprising at least one texture parameter; computing a quality measure of the animated face synthesized in accordance with current values of one or more animation parameters with respect to a predetermined facial expression; varying the one or more animation parameters according to an optimization algorithm; repeating the steps of synthesizing, computing, and varying until a predetermined criterion is met; and displaying facial expression of the character in accordance with values of the one or more animation parameters at the time the predetermined criterion is met. Examples of search and optimization algorithms include stochastic gradient ascent/descent, Broyden-Fletcher-Goldfarb-Shanno (“BFGS”), Levenberg-Marquardt, Gauss-Newton methods, Newton-Raphson methods, conjugate gradient ascent, natural gradient ascent, reinforcement learning, and others.

In an embodiment, a computer-implemented method includes capturing data representing extended facial expression appearance of a user. The method also includes analyzing the data representing the extended facial expression appearance of the user with a machine learning classifier to obtain a quality measure estimate of the extended facial expression appearance with respect to a predetermined prompt. The method further includes providing to the user the quality measure estimate.

In an embodiment, a computer-implemented method for setting animation parameters includes obtaining data representing appearance of an animated character synthesized in accordance with current values of one or more animation parameters with respect to a predetermined facial expression. The method also includes computing a current value of quality measure of the appearance of the animated character appearance synthesized in accordance with current values of one or more animation parameters with respect to the predetermined facial expression. The method additionally includes varying the one or more animation parameters according to an algorithm searching for improvement in the quality measure of the appearance of the animated character. The steps of synthesizing, computing, and varying may be repeated until a predetermined criterion of the quality measure is met, in searching for an improved set of the values for the parameters.

In an embodiment, a computing device includes at least one processor, and machine-readable storage coupled to the at least one processor. The machine-readable storage stores instructions executable by the at least one processor. When the instructions are executed by the at least one processor, the instructions configure the at least one processor to implement a machine learning classifier trained to compute a quality measure of facial expression appearance with a machine learning classifier to obtain a quality measure estimate of the facial expression appearance with respect to a predetermined prompt. The instructions further configure the processor to provide to a user the quality measure estimate. The facial appearance may be that of the user, another person, or an animated character.

These and other features and aspects of the present invention will be better understood with reference to the following description, drawings, and appended claims.

### BRIEF DESCRIPTION OF THE FIGURES

FIGS. 1A and 1B are simplified block diagram representations of a computer-based systems configured in accordance with selected aspects of the present description;

FIG. 2 illustrates selected steps of a process for providing feedback relating to the quality of a facial expression; and

FIG. 3 illustrates selected steps of a reinforcement learning process for adjusting animation parameters.

### DETAILED DESCRIPTION

In this document, the words “embodiment,” “variant,” “example,” and similar expressions refer to a particular apparatus, process, or article of manufacture, and not necessarily to the same apparatus, process, or article of manufacture. Thus, “one embodiment” (or a similar expression) used in one place or context may refer to a particular apparatus, process, or article of manufacture; the same or a similar expression in a different place or context may refer to a different apparatus, process, or article of manufacture. The expression “alternative embodiment” and similar expressions and phrases may be used to indicate one of a number of different possible embodiments. The number of possible embodiments/variants/examples is not necessarily limited to two or any other quantity. Characterization of an item as “exemplary” means that the item is used as an example. Such characterization of an embodiment/variant/example does not necessarily mean that the embodiment/variant/example is a preferred one; the embodiment/variant/example may but need not be a currently preferred one. All embodiments/variants/examples are described for illustration purposes and are not necessarily strictly limiting.

The words “couple,” “connect,” and similar expressions with their inflectional morphemes do not necessarily import an immediate or direct connection, but include within their meaning connections through mediate elements.

“Facial expression” as used in this document signify (1) large scale facial expressions, such as expressions of primary emotions (Anger, Contempt, Disgust, Fear, Happiness, Sadness, Surprise), Neutral expressions, and expression of affective state (such as boredom, interest, engagement, liking, disliking, wanting to buy, amusement, annoyance, confusion, excitement, contemplation/thinking, disbelieving, skepticism, certitude/sureness, doubt/unsureness, embarrassment, regret, remorse, feeling touched); (2) intermediate scale facial expression, such as positions of facial features, so-called “action units” (changes in facial dimensions such as movements of mouth ends, changes in the size of eyes, and movements of subsets of facial muscles, including movement of individual muscles); and (3) changes in low level facial features, e.g., Gabor wavelets, integral image features, Haar wavelets, local binary patterns (LBPs), Scale-Invariant Feature Transform (SIFT) features, histograms of gradients (HOGs), Histograms of flow fields (HOFFs), and spatio-temporal texture features such as spatiotemporal Gabors, and spatiotemporal variants of LBP, such as LBP-TOP; and other concepts commonly understood as falling within the lay understanding of the term.

“Extended facial expression” means “facial expression” (as defined above), head pose, and/or gesture. Thus, “extended facial expression” may include only “facial expression”; only head pose; only gesture; or any combination of these expressive concepts.

The word “image” refers to still images, videos, and both still images and videos. A “picture” is a still image. “Video” refers to motion graphics.

“Causing to be displayed” and analogous expressions refer to taking one or more actions that result in displaying. A computer or a mobile device (such as a smart phone, tablet, Google Glass and other wearable devices), under control of program code, may cause to be displayed a picture and/or text, for example, to the user of the computer. Additionally, a server computer under control of program code may cause a web page or other information to be displayed by making the web page or other information available for access by a client computer or mobile device, over a network, such as the Internet, which web page the client computer or mobile device may then display to a user of the computer or the mobile device.

“Causing to be rendered” and analogous expressions refer to taking one or more actions that result in displaying and/or creating and emitting sounds. These expressions include within their meaning the expression “causing to be displayed,” as defined above. Additionally, the expressions include within their meaning causing emission of sound.

A quality measure of an expression is a quantification or rank of the expressivity of an image with respect to a particular expression, that is, how closely the expression is conveyed by the image. The quality of an expression generally depends on multiple factors, including these: (1) spatial location of facial landmarks, (2) texture, (3) timing and dynamics. Some or all of these factors may be considered in computing the measure of the quality of the he quality of an expression will depend on multiple factors including: (1) spatial location of facial landmarks, (2) texture. (3) timing and dynamics. The system we propose takes these factors into consideration to provide the user with a measure of the quality of the expression in the image.

Other and further explicit and implicit definitions and clarifications of definitions may be found throughout this document.

Reference will be made in detail to several embodiments that are illustrated in the accompanying drawings. Same reference numerals are used in the drawings and the description to refer to the same apparatus elements and method steps. The drawings are in a simplified form, not to scale, and omit apparatus elements, method steps, and other features that may be added to the described systems and methods, while possibly including certain optional elements and steps.

In selected embodiments, a computer system is specially configured to measure the quality of the expressions of an animated character, and to apply reinforcement learning to select the values for the character's animation parameters. The basic process is analogous to what is described throughout this document in relation to providing feedback regarding extended facial expressions of human users, except that the graphic flow or still pictures of an animated character may be input into the system, rather than the videos or pictures of a human. Here, the quality of expression of the animation character is evaluated and used as a feedback signal, and the animation parameters are automatically or manually adjusted based on this feedback signal from the automated expression recognition. Adjustments to the parameters may be selected using reinforcement learning techniques such as temporal difference (TD) learning. The parameters may include conventional animation parameters that relate essentially to facial appearance and movement, as well as animation parameters that relate and control the surface or skin texture, that is, the appearance characteristics that suggest or convey the tactile quality of the surface, such as wrinkling and goose bumps. Furthermore, we include in the meaning of “texture” grey and other shading properties. A texture parameter is something that an animator can control directly, e.g., the degree of curvature of a surface in a 3D model. This will result on a change in texture that can be measured using Gabor filters. Texture parameters may be pre-defined.

The reinforcement learning method may be geared towards learning how to adjust animation parameters, which change the positions of facial features, to maximize extended facial expression response, and/or how to change the texture patterns on the image to maximize the facial expression response. Reinforcement learning algorithms may attempt to increase/maximize a reward function, which may essentially be the quality measure output of a machine learning extended facial expression system trained on the particular expression that the user of the system desires to express with the animated character. The animation parameters (which may include the texture parameters) are adjusted or “tweaked” by the reinforcement learning process to search the animation parameter landscape (or part of the landscape) for increased reward (quality measure). In the course of the search, local or global maxima may be found and the parameters of the character may be set accordingly, for the targeted expression.

A set of texture parameters may be defined as a set of Gabor patches at a range of spatial scales, positions, and/or orientations. The Gabor patches may be randomly selected to alter the image, e.g., by adding the pixel values in the patch to the pixel values at a location in the face image. The parameters may be the weights that define the weighted combination of Gabor patches to add to the image. The new character face image may then be passed to the extended facial expression recognition/analysis system. The output of the system provides feedback as to whether the new face image receives a higher or lower response for the targeted expression (e.g., “happy,” “sad,” “excited”). This change in response is used as a reinforcement signal to learn which texture patches, and texture patch combinations, create the greatest response for the targeted expression.

The texture parameters may be pre-defined, such as the bank of Gabor patches in the above example. They may also be learned from a set of expression images. For example, a large set of images containing extended facial expressions of human faces and/or cartoon faces showing a range of extended facial expressions may be collected. These faces may then be aligned for the position of specific facial feature points. The alignment can be done by marking facial feature points by hand, or by using a feature point tracking algorithm. The face images are then warped such that the feature points are aligned. The remaining texture variations are then learned. The texture is parameterized through learning algorithms such as principal component analysis (PCA) and/or independent component analysis (ICA). The PCA and ICA algorithms learn a set of basis images. A weighted combination of these basis images defines a range of image textures. The parameters are the weights on each basis image. The basis images may be holistic, spanning the whole M×M face image, or local, associated with a specific N×N window.

In selected embodiments, a computer system (which term includes smartphones, tablets, and wearable devices such as Google Glass and smart watches) is specially configured to provide feedback to a user on the quality of the user's extended facial expressions, using machine learning classifiers of extended facial expression recognition. The system is configured to prompt the user to make a targeted extended facial expression selected from a number of extended facial expressions, such as “sad,” “happy,” “disgusted,” “excited,” “surprised,” “fearful,” “contemptuous,” “angry,” “indifferent/uninterested,” “empathetic,” “raised eyebrow,” “nodding in agreement,” “shaking head in disagreement,” “looking with skepticism,” or another expression; the system may operate with any number of such expressions. A still picture or a video stream/graphic clip of the expression made by the user is captured and is passed to an automatic extended facial expression recognition/analysis system. Various measurements of the extended facial expression of the user are made and compared to the corresponding metrics of the targeted expression. Information regarding the quality of the expression of the user is provided to the user, for example, displayed, emailed, verbalized and spoken/sounded.

In some variants, the prompt or request may be indirect: rather than prompting the user to produce an expression of a specific emotion, a situation is presented to the user and the user is asked to produce a facial expression appropriate to the situation. For example, a video or computer animation may be shown of a person talking in a rude manner in the context of a business transaction. During this time, the person using the system would be requested to display a facial expression or combination of facial expressions appropriate for that situation. This may be useful, for example, in training customer service personnel to deal with angry customers.

The user of the system may be an actor in the entertainment industry; a person with an affective or neurological disorder (e.g., an autism spectrum disorder, Parkinson's disease, depression) who wants to improve his or her ability to produce and understand natural looking facial expressions of emotion; a person with no particular disorder who wants to improve the appearance and dynamics of his or her non-verbal communication skills; a person who wants to learn or interpret the standard facial expressions used in different cultures for different situations; or any other individual. The system may also be used by companies to train their employees on the appropriate use of facial expressions in different business situations or transactions.

Expression quality of the expression made by the user or the animation character may be measured using the output(s) of one or more classifiers of extended facial expressions. A classifier of extended facial expression is a machine learning classifier, which may implement support vector machines (“SVMs”), boosting classifiers (such as cascaded boosting classifiers, Adaboost, and Gentleboost), multivariate logistic regression (“MLR”) techniques, “deep learning” algorithms, action classification approaches from the computer vision literature, such as Bags of Words models, and other machine learning techniques, whether mentioned anywhere in this document or not.

The output of an SVM may be the margin, that is, the distance to the separating hyperplane between the classes. The margin provides a measure of expression quality. For cascaded boosting classifiers (such as Adaboost), the output may be an estimate of the likelihood ratio of the target class (e.g., “sad”) to a non-target class (e.g., “happy” and “all other expressions”). This likelihood ratio provides a measure of expression quality. In embodiments, the system may be configured to record the temporal dynamics of the intensity, or likelihood outputs provided by the classifiers. In embodiments, the output may be an intensity measure indicating the level of contraction of different facial muscle or the level of intensity of the observed expression.

For systems based on single frame action, a model of the probability distribution of the observed outputs in the sample is developed. This can be done, for example, using standard density estimation methods, probabilistic graphical models, and/or discriminative machine learning methods.

For system that evaluate expression dynamics (rather than just single frame expression), a model is developed for the observed output dynamics. This can be done using probabilistic dynamical models, such as Hidden Markov Processes, Bayesian Nets, Recurrent Neural Networks, Kalman filters, and/or Stochastic Difference and Stochastic Differential equation models.

The quality measure may be obtained as follows. A collection of images (videos and/or still pictures) is selected by experts for providing high quality in the context of a target expressions. (An “expert” has expertise experts the facial action coding system or analogous ways for coding facial expressions; an “expert” may also be a person with expertise in the expressions appropriate for a particular situation, for example, people familiar with expressions appropriate in the course of conducting Japanese business transactions.) The collection of images may also include negative examples—images that have been selected by the experts for not being particularly good examples of the target expression, or not being appropriate for the particular situation in which the expression is supposed to be produced. The images are processed by an automatic expression recognition system, such as UCSD's CERT, Emotient's FACET SDK. Machine learning methods may then be used to estimate the probability density of the outputs of the system both at the single frame level and across frame sequences in videos. Example methods for single frame level include Kernel probability density estimation and probabilistic graphical models. Example methods for video sequences include Hidden Markov Models, Kalman filters and dynamic Bayes nets. These models can provide an estimate of the likelihood of the observed expression parameters given the correct expression group, and an output of the likelihood of the observed expression parameters given the incorrect expression group. Alternatively, the model may provide an estimate of the likelihood ratio of the observed expression parameters given the correct and incorrect expression groups. The quality score of the observed expression may be based on matching the correct group as much as possible and being as different as possible from the incorrect expression group. For example, the quality score would increase as the likelihood of the image given the correct group increases, and decreases as the likelihood of the image given the incorrect group increases.

At the time a quality measure needs to be computed for a user-produced expression appropriate to the given situation, or for an animated character, the likelihood of the expression given the probability model for the correct expression or the correct expression dynamics is computed. The higher the computed likelihood, the higher the quality of the expression. In examples, the relationship between the likelihood and the quality is a monotonic one.

The quality measure may be displayed or otherwise rendered (verbalized and sounded) to the user in real-time, or be a delayed visual display and/or audio vocalization; it may also be emailed to the user, or otherwise provided to the user and/or another person, machine, or entity. For example, a slide-bar or a thermometer display may increase according to the integral of the quality measure over a specific time period. There may be audio feedback with or without visual feedback. For example, a tone may increase in frequency as the expression improves quality. There may be a signal when the quality reaches a pre-determined goal, such as a bell or applause in response to the quality reaching or exceeding a specified threshold. Another form of feedback is to have an animated character start to move its face when the user makes the correct facial configuration for the target emotion, and then increase the animated character's own expression as the quality of the user's expression increases (improves). The system may also provide numerical or other scores of the quality measure, such as a letter grade A-F, or a number on 1-100 scale, or another type of score or grade. In embodiments, multiple measures of expression quality are estimated and used. In embodiments, multiple means of providing the expression quality feedback to the person are used.

The system that provides the feedback to the users may be implemented on a user mobile device. The mobile device may be a smartphone, a tablet, a Google Glass device, a smart watch, or another wearable device. The system may also be implemented on a personal computer or another user device. The user device implementing the system (of whatever kind, whether mobile or not) may operate autonomously, or in conjunction with a website or another computing device with which the user device may communicate over a network. In the website version, for example, users may visit a website and receive feedback on the quality of the users' extended facial expressions. The feedback may be provided in real-time, or it may be delayed. Users may submit live video with a webcam, or they may upload recorded and stored videos or still images. The images (still, video) may be received by the server of the website, such as a cloud server, where the facial expressions are measured with an automated system such as the Computer Expression Recognition Toolbox (“CERT”) and/or FACET technology for automated expression recognition. (CERT was developed at the machine perception laboratory of the University of California, San Diego; FACET was developed by Emotient.) The output of the automated extended facial expression recognition system may drive a feedback display on the web. The users may be provided with the option to compare their current scores to their own previous scores, and also to compare their scores (current or previous) to the scores of other people. With permission, the high scorers may be identified on the web, showing their usernames, and images or videos.

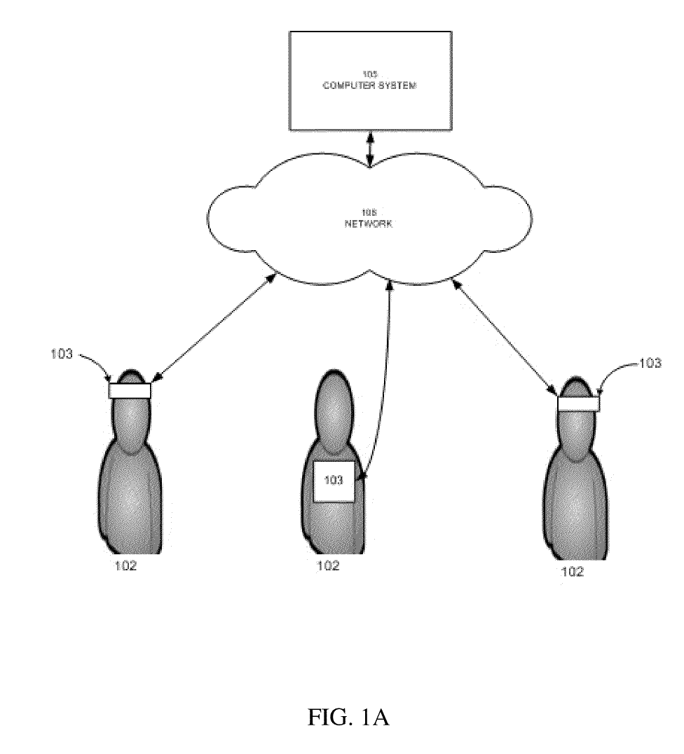

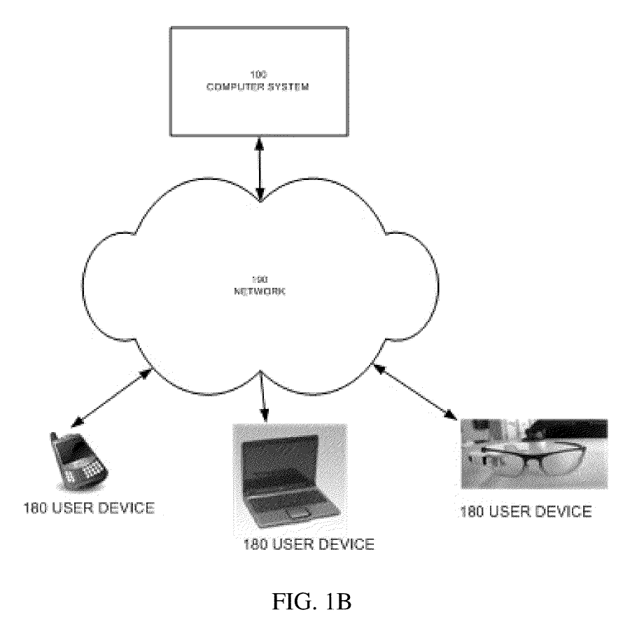

In some embodiments, a distributed sensor system may is used. For example, multiple people may be wearing wearable cameras, such as Google Glass wearable devices. The device worn by a person A captures the expressions of a person B, and the device worn by the person B captures the expressions of the person A. When the devices are networked, either person or both persons can receive quality scores of their own expressions, which have been observed using the cameras worn by the other person. That is, the person A may receive quality scores generated from expressions captured by the camera worn by B and by cameras of still other people; and the person B may receive quality scores generated from expressions captured by the camera worn by A and by cameras of other people. FIG. 1A illustrates this paradigm, where users 102 wear camera devices (such as Google Glass devices) 103, which devices are coupled to a system 105 through a network 108.

The extended facial expressions for which feedback is provided may include the seven basic emotions and other emotions; states relevant to interview success, such as trustworthy, confident, competent, authoritative, compliant, and other states such as Like, Dislike, Interested, Bored, Engaged, Want to buy, Amused, Annoyed, Confused, Excited, Thinking, Disbelieving/Skeptical), Sure, Unsure, Embarrassed, Sorry, Touched, Bored, Neutral, various head poses, various gestures, Action Units, as well as other expressions falling under the rubrics of facial expression and extended facial expression defined above. In addition, feedback may be provided to train people to avoid Action Units associated with deceit.

Classifiers of these and other states may be trained using the machine learning methods described or mentioned throughout this document.

The feedback system may also provide feedback for specific facial actions or facial action combinations from the facial action coding system, for gestures, and for head poses.

FIG. 1B is a simplified block diagram representation of a computer-based system 100, configured in accordance with selected aspects of the present description to provide feedback relating to the quality of a facial expression to a user. The system 110 interacts through a communication network 190 with various users at user devices 180, such as personal computers and mobile devices (e.g., PCs, tablets, smartphones, Google Glass and other wearable devices).

The systems 105/110 may be configured to perform steps of a method (such as the methods 200 and 300 described in more detail below) for training an expression classifier using feedback from extended facial expression recognition.

FIGS. 1A and 1B do not show many hardware and software modules, and omit various physical and logical connections. The systems 105/110 and the user devices 103/180 may be implemented as special purpose data processors, general-purpose computers, and groups of networked computers or computer systems configured to perform the steps of the methods described in this document. In some embodiments, the system is built using one or more of cloud devices, smart mobile devices, and wearable devices. In some embodiments, the system is implemented as a plurality of computers interconnected by a network.

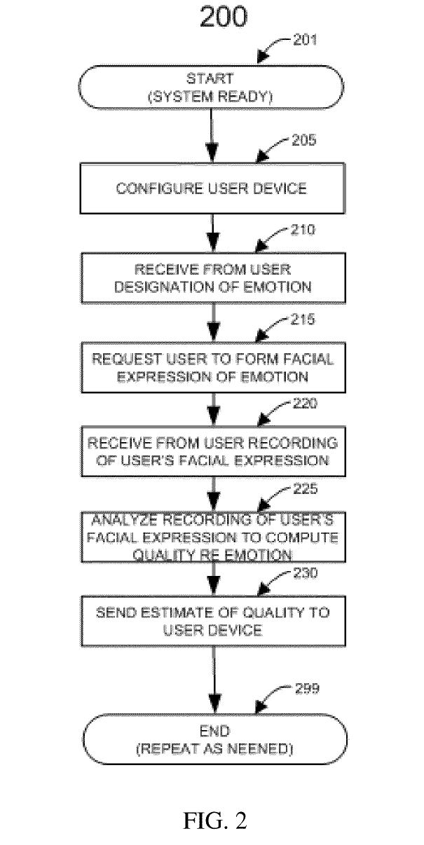

FIG. 2 illustrates selected steps of a process 200 for providing feedback relating to the quality of a facial expression or extended facial expression to a user. The method may be performed by the system 105/110 and/or the devices 103/180 shown in FIGS. 1A and 1B.

At flow point 201, the system and a user device are powered up and connected to the network 190.

In step 205, the system communicates with the user device, and configures the user device 180 for interacting with the system in the following steps.

In step 210, the system receives from the user a designation or selection of the targeted extended facial expression.

In step 215, the system prompts or requests the user to form an appearance corresponding to the targeted expression. As has already been mentioned, the prompt may be indirect, for example, a situation may be presented to the user and the user may be asked to produce an extended facial expression appropriate to the situation. The situation may be presented to the user in the form of video or animation, or a verbal description.

In step 220, the user forms the appearance of the targeted or prompted expression, the user device 180 captures and transmits the appearance of the expression to the system, and the system receives the appearance of the expression from the user device.

In step 225, the system feeds the image (still picture or video) of the appearance into a machine learning expression classifier/analyzer that is trained to recognize the targeted or prompted expression and quantify some quality measure of the targeted or prompted expression. The classifier may be trained on a collection of images of subjects exhibiting expressions corresponding to the targeted or prompted expression. The training data may be obtained, for example, as is described in U.S. patent application entitled COLLECTION OF MACHINE LEARNING TRAINING DATA FOR EXPRESSION RECOGNITION, by Javier R. Movellan, et al., Ser. No. 14/177,174, filed on or about 10 Feb. 2014, attorney docket reference MPT-1010-UT; and in U.S. patent application entitled DATA ACQUISITION FOR MACHINE PERCEPTION SYSTEMS, by Javier R. Movellan, et al., Ser. No. 14/178,208, filed on or about 11 Feb. 2014, attorney docket reference MPT-1012-UT. Each of these applications is incorporated by reference herein in its entirety. As another example, the training data may also be obtained by eliciting responses to various stimuli (such as emotion-eliciting stimuli), recording the resulting extended facial expressions of the individuals from whom the responses are elicited, and obtaining objective or subjective ground truth data regarding the emotion or other affective state elicited.

The expressions in the training data images may be measured by automatic facial expression measurement (AFEM) techniques. The collection of the measurements may be considered to be a vector of facial responses. The vector may include a set of displacements of feature points, motion flow fields, facial action intensities from the Facial Action Coding System (FACS). Probability distributions for one or more facial responses for the subject population may be calculated, and the parameters (e.g., mean, variance, and/or skew) of the distributions computed.

The machine learning techniques used here include support vector machines (“SVMs”), boosted classifiers such as Adaboost and Gentleboost, “deep learning” algorithms, action classification approaches from the computer vision literature, such as Bags of Words models, and other machine learning techniques, whether mentioned anywhere in this document or not.

After the training, the classifier may provide information about new, unlabeled data, such as the estimates of the quality of new images.

In one example, the training of the classifier and the quality measure are performed as follows:

First, a sample of images (e.g., videos) of people making facial expressions appropriate for a given situation is obtained.

One or more experts confirm that, indeed, the expression morphology and/or expression dynamics observed in the images are appropriate for the given situation. For example, a Japanese expert may verify that the expression dynamics observed in a given video are an appropriate way to express grief in Japanese culture.

The images are run through the automatic expression recognition system, to obtain the frame-by-frame output of the system.

In alternative implementations, videos of expressions and expression dynamics that are not appropriate for a given situation (negative examples) are collected and also used in the training.

In step 230, the system 105/110 sends to the user device 180 the estimate of the quality by itself or with additional information, such as predetermined suggestions for improving the quality of the facial expression to make it appear more like the target expression. Also, the system may provide specific information for why the quality measure is large or small. For example, the system may be configured to indicate that the dynamics may be correct, but the texture may need improvement. Similarly, the system may be configured to indicate that the morphology is correct, bur the dynamics need improvement.

At flow point 299, the process 299 may terminate, to be repeated as needed for the same user and/or other users, and for the same target expression or another target expression.

The process 200 may also be performed by a single device, for example, the user device 180. In this case, the user device 180 receives from the user a designation or selection of the targeted extended facial expression, prompts or requests the user to form an appearance corresponding to the targeted expression, captures the appearance of the expression produced by the user, processes the image of the appearance with a machine learning expression classifier/analyzer trained to recognize the targeted or prompted expression and quantify a quality measure, and renders to the user the quality measure and/or additional information.

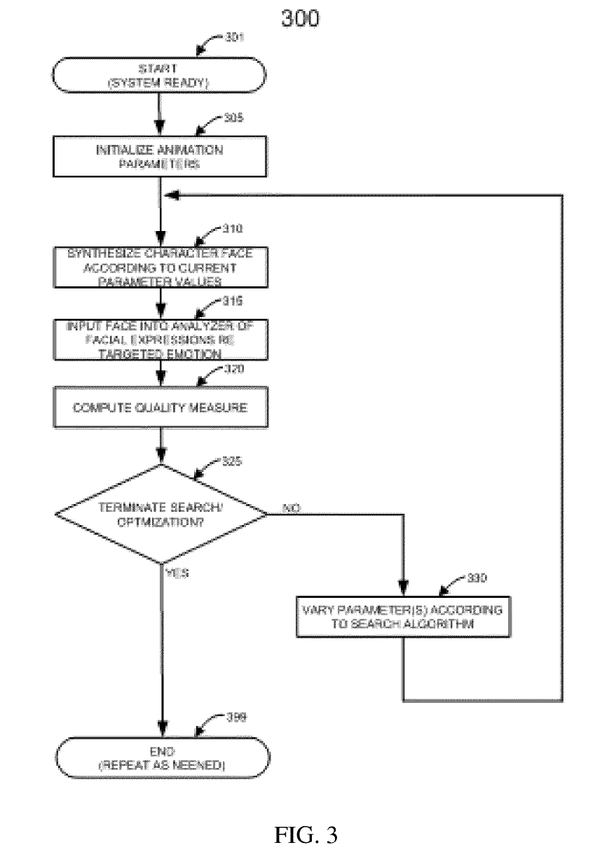

FIG. 3 illustrates selected steps of a reinforcement learning process 300 for adjusting animation parameters, beginning with flow point 301 and ending with flow point 399.

In step 305, initial animation parameters are determined, for example, received from the animator or read from a memory device storing a predetermined initial parameter set.

In step 310, the character face is created in accordance with the current values of the animation parameters.

In step 315, the face is inputted into a machine learning classifier/analyzer for the targeted extended facial expression (e.g., expression of the targeted emotion).

In step 320, the classifier computes a quality measure of the current extended facial expression, based on the comparison with the targeted expression training data.

Decision block 325 determines whether the reinforcement learning process should be terminated. For example, the process may be terminated if a local maxima of the parameter landscape is found or approached, or if another criterion for terminating the process has been reached. In embodiments, the process is terminated by the animator. If the decision is affirmative, process flow terminates in the flow point 399.

Otherwise, the process continues to step 330, where one or more of the animation parameters (possibly including one or more texture parameters) are varied in accordance with some (maxima) searching algorithm.

Process flow then returns to the step 310.

The system and process features described throughout this document may be present individually, or in any combination or permutation, except where presence or absence of specific feature(s)/element(s)/limitation(s) is inherently required, explicitly indicated, or otherwise made clear from the context.

Although the process steps and decisions (if decision blocks are present) may be described serially in this document, certain steps and/or decisions may be performed by separate elements in conjunction or in parallel, asynchronously or synchronously, in a pipelined manner, or otherwise. There is no particular requirement that the steps and decisions be performed in the same order in which this description lists them or the Figures show them, except where a specific order is inherently required, explicitly indicated, or is otherwise made clear from the context. Furthermore, not every illustrated step and decision block may be required in every embodiment in accordance with the concepts described in this document, while some steps and decision blocks that have not been specifically illustrated may be desirable or necessary in some embodiments in accordance with the concepts. It should be noted, however, that specific embodiments/variants/examples use the particular order(s) in which the steps and decisions (if applicable) are shown and/or described.

This document describes the inventive apparatus, methods, and articles of manufacture for providing feedback relating to the quality of a facial expression. This document also describes adjustment of animation parameters related to facial expression through reinforcement learning. In particular, this document describes improvement of animation through morphology, i.e., the spatial distribution and shape of facial landmarks. This is controlled with traditional animation parameters like FAPS or FACS based animation. Furthermore, this document describes texture parameter manipulation (e.g., wrinkles and shadows produced by the deformation of facial tissues created by facial expressions) is described. Still further, the document describes dynamics of how the different components of the facial expression evolve through time. The described technology can help people animation system get better, by scoring animations produced by the computer and allowing the animators to make changes by hand to get better. The described technology improves the animation improved automatically, using optimization methods. Here, the animation parameters are the variables that affect the optimized function. The quality of expression output provided by the described systems and methods may be the function optimized.

The specific embodiments or their features do not necessarily limit the general principles described in this document. The specific features described herein may be used in some embodiments, but not in others, without departure from the spirit and scope of the invention(s) as set forth herein. Various physical arrangements of components and various step sequences also fall within the intended scope of the invention. Many additional modifications are intended in the foregoing disclosure, and it will be appreciated by those of ordinary skill in the pertinent art that in some instances some features will be employed in the absence of a corresponding use of other features. The illustrative examples therefore do not necessarily define the metes and bounds of the invention and the legal protection afforded the invention, which function is carried out by the claims and their equivalents.

What is claimed is:

1. A computer-implemented method comprising steps of:
capturing data representing facial expression appearance of a user;
analyzing the data representing the facial expression appearance of the user with a machine learning classifier to obtain a quality measure estimate of the facial expression appearance with respect to a predetermined prompt; and
providing to the user the quality measure estimate.

2. A computer-implemented method as in claim 1, further comprising:
providing to the user additional information, wherein the additional information comprises a suggestion for improving response of the user to the predetermined prompt.

3. A computer-implemented method as in claim 1, further comprising:
providing the predetermined prompt to the user.

4. A computer-implemented method as in claim 3, wherein:
the predetermined prompt comprises a request to display a facial expression of a predetermined emotion or affective state.

5. A computer-implemented method as in claim 3, wherein:
the predetermined prompt comprises a presentation of a situation and a request to produce a facial expression appropriate to the situation.

6. A computer-implemented method as in claim 3, wherein:
the predetermined prompt comprises a presentation of a situation and a request to produce a facial expression appropriate to the situation, wherein the situation pertains to customer service within purview of the user.

7. A computer-implemented method as in claim 1, wherein:
the step of analyzing is performed by a first system;
the step of capturing is performed by a second system, the second system being a mobile device coupled to the first system through a wide area network.

8. A computer-implemented method as in claim 7, wherein the mobile device is a wearable device.

9. A computer-implemented method as in claim 1, wherein:
the step of analyzing is performed by a first system;
the step of capturing is performed by a first mobile wearable device coupled to the first system through a network; and
the step of providing to the user the quality measure estimate comprises:
transmitting the quality estimate from the first system to a second wearable device coupled to the first system through the network; and
rendering the quality measure estimate to the user by the second wearable device.

10. A computer-implemented method as in claim 9, wherein the second wearable device is built into glasses.

11. A computer-implemented method as in claim 1, wherein the predetermined prompt is designed to elicit an expression corresponding to a primary emotion.

12. A computer-implemented method as in claim 1, wherein:
the user suffers from an affective or neurological disorder;
the method further comprising:
providing to the user additional information, wherein the additional information comprises at least one of a suggestion for improving expressiveness and improving expression understanding of the people with the disorder.

13. A computer-implemented method as in claim 1, wherein:
the user is of a first cultural background; and
the quality measure estimate pertains to a second cultural background.

14. A computer-implemented method for setting animation parameters, the method comprising steps of:
obtaining data representing appearance of an animated character synthesized in accordance with current values of one or more animation parameters with respect to a predetermined facial expression;
computing a current value of quality measure of the appearance of the animated character appearance synthesized in accordance with current values of one or more animation parameters with respect to the predetermined facial expression;
varying the one or more animation parameters according to an algorithm searching for improvement in the quality measure of the appearance of the animated character; and
repeating the steps of synthesizing, computing, and varying until a predetermined criterion of the quality measure is met.

15. A computer-implemented method as in claim 14, wherein the quality measure is a measure of expressiveness of a targeted emotion or affective state.

16. A computer-implemented method as in claim 15, wherein the step of varying is performed automatically by a computer system.

17. A computer-implemented method as in claim 14, wherein the step of obtaining comprises:
synthesizing an animated face of a character in accordance with current values of one or more animation parameters, the one or more animation parameters comprising at least one texture parameter.

18. A computer-implemented method as in claim 14, further comprising:
displaying facial expression of the character in accordance with values of the one or more animation parameters at the time the predetermined criterion is met.

19. A computer-implemented method as in claim 14, wherein the one or more animation parameters comprise at least one texture parameter.

20. A computing device comprising:
at least one processor; and
machine-readable storage, the machine-readable storage being coupled to the at least one processor, the machine-readable storage storing instructions executable by the at least one processor;
wherein:
the instructions, when executed by the at least one processor, configure the at least one processor to implement a machine learning classifier trained to compute a quality measure of facial expression appearance with a machine learning classifier to obtain a quality measure estimate of the facial expression appearance with respect to a predetermined prompt; and
providing to a user the quality measure estimate.
